(19) United States
(12) Patent Application Publication
(10) Pub. No.: US 2012/0275354 A1
(43) Pub. Date: Nov. 1, 2012

(54) ASYMMETRIC WHITE SPACE COMMUNICATIONS

(75) Inventor: Frederic Francois Villain, Caen (FR)

(73) Assignee: NXP B.V., Eindhoven (NL)

(21) Appl. No.: 13/241,050

(22) Filed: Sep. 22, 2011

(30) Foreign Application Priority Data
Apr. 26, 2011 (EP) 11290202.8

(51) Int. Cl. H04J 1/02; H04L 5/14

(52) U.S. Cl. 370/281

(57) ABSTRACT

A wireless transceiver comprising: a receiver adapted to receive signals in a television broadcast band; and a transmitter adapted to transmit signals in a different band. Also provided is a counterpart transceiver. The latter transceiver comprises: a transmitter adapted to transmit signals in a television broadcast band; and a receiver adapted to receive signals in the different band.

This application claims the priority under 35 U.S.C. §119 of European patent application no. 11290202.8, filed on Apr. 26, 2011, the contents of which are incorporated by reference herein.

### FIELD OF THE INVENTION

This invention relates to devices which communicate wirelessly in unoccupied portions of the radio spectrum, in bands that are allocated for television broadcast signals. These allocated but unused spectral bands are called “white space”.

### BACKGROUND OF THE INVENTION

Recently, telecommunications regulators, such as the Federal Communications Commission (FCC) in the USA, have recognized that white space in the TV broadcast band can be reused for local or regional communications, in order to make more efficient use of the overall available spectrum.

Channels in the TV broadcast band are allocated to specific licensees—that is, the TV band is a licensed band. Traditionally, a licence to use a specified part of the spectrum was exclusive, in the sense that users other than the licensed operator were forbidden to use that part of the spectrum. However, this led to inefficient use of the radio spectrum.

Communication using white space in the TV band amounts to reuse of previously-allocated parts of the spectrum. This reuse is unlicensed—that is, no licence is required to make use of the unoccupied portions of spectrum. Instead, an unlicensed device using the white space must ensure, at all times, that its transmissions do not interfere with those of a licensed operator. Thus, a device wishing to use a particular bandwidth of white space must maintain an awareness of potential and actual broadcasts by other transmitters in that bandwidth.

The FCC has specified the detailed requirements that must be met by unlicensed Television Band Devices (TVBDs). See, for example, FCC10-174

Second Memorandum and Order, Sep. 23, 2010. These requirements include (for certain types of device) providing geolocation functionality, so that the device can determine its own location and search a database of TV band spectrum-allocations, so as to establish which bands are available for use at that particular location. In addition, the regulations suggest the possibility for the devices to implement a spectrum-sensing function, whereby the device can detect whether a channel is currently occupied by an authorised (licensed) service or another unlicensed TVBD.

In addition to these measures for avoiding in-band interference by TVBDs, the regulations also impose stringent conditions on the level of out-of-band interference. These conditions ensure that the TVBD does not interfere with television signals (or other services) in adjacent spectral bands, or non-adjacent bands further removed from the band being used by the TBD.

All of these strict requirements tend to increase the complexity and therefore cost of TV band devices. Some of the problems posed by the technical requirements are discussed in S. J. Shellhammer, A. K. Sadek, and W. Zhang, “Technical Challenges for Cognitive Radio in the TV White Space Spectrum,” (invited paper) in Proc. Information Theory and Applications (ITA) Workshop, San Diego, Calif., February 2009.

### SUMMARY OF THE INVENTION

According to a first aspect of the present invention, there is provided a wireless transceiver comprising:

a first receiver adapted to receive a data signal from a remote device in a television broadcast band; and

a transmitter adapted to transmit a data signal to the remote device using a different frequency band, which is not a television broadcast band,

the transmitter and receiver thereby being adapted to implement frequency division duplex communication between the transceiver and remote device.

The present inventor has recognised that it is advantageous to implement an asymmetric communications link, using the TV band for communication in one direction and another, non-TV band for communication in the opposite direction. This means that only one of the two communicating devices needs to obey the stringent regulatory requirements for white-space transmissions in the TV band. The asymmetric strategy may be particularly advantageous in a “one-to-many” communications scenario. For example, one device may be an access-point or gateway device which communicates with multiple remote devices. In this case, the downlink from the access-point to the remote device can use TV band white-space, and the uplink from each remote device can use a different band. Thus, only one device in the network is transmitting in the TV band. In this exemplary scenario, the transceiver device according to the first aspect of the invention corresponds to the remote device. This device is simplified and made cheaper to manufacture because it transmits in a band other than a TV band. It does not need to meet the strict spectral mask conditions or to implement the additional functionality for interference avoidance that is required of a TVBD. Nevertheless, the device is able to receive signals from a TVBD through its receiver.

The transmitter is adapted to transmit signals back to the source from which the receiver receives its signals, thereby realising full-duplex communication between two nodes. Likewise, the signals transmitted by the transmitter will be different from the signals received by the receiver, so that the transceiver is not merely a repeater, re-broadcasting the received signals.

Full-duplex communication means sending and receiving application data over both bands. Here, the full-duplex communication uses frequency division: the television broadcast band is used for communication in one direction (for example, downstream), and the different frequency band is used in the opposite direction (for example, upstream). Both the received data signal and the transmitted data signal of the wireless transceiver comprise application data. This bidirectional communication contrasts with, for example, using a separate frequency band merely as a control channel, to manage data communications in the TV band. Communication according to embodiments of the invention is typically characterised in that the data originates and/or is destined for a device other than the transceiver and the other device (that is, the device at the other end of the full-duplex wireless link). In this way, the duplex communication between the transceiver and other device forms one link in a chain of communication. Thus, the transmitted data signal may comprise a packet of data, such as a http request, to be delivered over the internet and destined for a remote computer, such as a web server. The received data signal may comprise a webpage served by the web server in response to the request.

The TV broadcast band may comprise Very High Frequency (VHF) or Ultra High Frequency (UHF) signals. The TV band signals may preferably be in the bandwidth ranges of 300 MHz to 1 GHz (which also covers several useful ISM bands: 315/434/869/915 MHz), more preferably in the range 460-608 MHz, or 614-698 MHz.

The different band is a band which does not overlap with the range of frequencies allocated for TV broadcast, in a given country or region in which the device is intended to be operated. Thus, the different band preferably does not overlap with the specific numerical ranges 460-608 MHz and 614-698 MHz mentioned above

The transmitter is preferably tuneable, so that the different band can be chosen or changed during operation of the transceiver. The transmitter may be configurable by software or firmware controlling the operation of the transceiver, for example.

The receiver is preferably tuneable, so that the TV band to be used for receiving data can be chosen and changed during operation of the transceiver. The receiver may be tuneable in the range 45 MHz to 1 GHz. Thus, the frequency of operation of one or both of the transmitter and receiver may be configurable during use of the transceiver.

The wireless transceiver may further comprise a geolocation unit, wherein the transceiver is adapted to: determine its location using the geolocation unit, and select said different frequency band in dependence upon the determined location.

This allows the transceiver device to automatically configure itself dependent on the region of operation. The different frequency band, which the transceiver will use to transmit data, should be chosen based on the region of operation. This is because frequency spectrum is allocated (regulated) differently in different countries and/or regions of the world. By providing a geolocation unit, and configuring itself automatically, the transceiver can avoid generating interference and/or breach of local regulations without the need for the user to adjust the configuration manually.

The transceiver may comprise a second receiver adapted to receive a control signal from the other device in said different frequency band, the transceiver being adapted to select the television band according to instructions contained in the control signal.

In this way, the different frequency band is used initially to configure the TV band which the transceiver will later use to receive application data from the other device. The TV band used will typically have a higher bandwidth than the frequency band used for the configuration. Therefore, the transceiver is using a procedure of initial communication, using the different band, in order to set up (higher bandwidth and higher data-rate) communications in the TV band. An advantage of this configuration technique is that the transceiver does not take responsibility for choosing the TV band to be used. Instead, it receives this information in instructions from the other device (for example, an access-point). In this way, the complexity of the transceiver is minimised. The choice of frequencies can be centrally managed, if the other device is a base-station or access-point.

The receiver may be adapted to receive signals in the television band that are modulated according to an Orthogonal Frequency Division Multiplexing, OFDM, modulation scheme.

OFDM is a preferred method of modulation for communications in the TV band white-space spectrum. It is suitable for meeting the strict spectral-mask specification, which prevents the transmissions from interfering with other signals in neighbouring channels.

The different band is preferably an unlicensed band.

The band used for the uplink will typically be a completely unlicensed band—that is, a band in which no operator has a specific licence to use an allocated portion of bandwidth. This makes unlicensed spectrum suitable for ad-hoc wireless communications. Typically, a transmitter using such a band is responsible for ensuring that its own transmissions do not unduly interfere with other devices sharing the band. At the same time the transmitter should ensure that its transmissions are robust to interference from other devices—since the band is unlicensed, it can be expected that it must be shared with other users.

The unlicensed band is preferably an Industrial, Scientific and Medical, ISM, band.

The unlicensed band is preferably the ISM 900 band, 902-928 MHz.

This band is suitable for the uplink in countries in Region 2 (the Americas, Greenland, and some Pacific Islands).

The transmitter may use a spread spectrum modulation scheme.

This is one suitable type of modulation scheme for the uplink, especially if the uplink uses an unlicensed part of the spectrum. Spread spectrum techniques do not cause significant interference, because the signal power is spread over a wide bandwidth. They are also robust to interfering signals transmitted by other devices. Preferably, a Direct Sequence Spread Spectrum (DSSS) modulation scheme is used. FCC regulations allow DSSS modulation systems to operate at up to 1 W of output power.

The transceiver may be a mobile device.

It is particularly beneficial to simplify and reduce the cost of a mobile device, which may be one of a large number of similar devices communicating with a fixed access-point or base station.

According to a second aspect of the invention, there is provided a wireless transceiver comprising:

a transmitter adapted to transmit a data signal to another device in a television broadcast band; and

a receiver adapted to receive a data signal from that other device in a different frequency band, which is not a television broadcast band,

the transmitter and receiver thereby being adapted to implement frequency division duplex communication between the transceiver and the other device.

The device according to the second aspect of the invention corresponds to the access-point in the scenario discussed earlier above. This is a TVBD which has a receiver for receiving signals from its counterpart (remote) device, in a band other than the TV band. Thus, only the access-point device needs to fulfil the requirements for TV band white space transmission. This reduces the cost of the overall network, and the remote devices in particular.

Preferably, the transmitter is adapted to transmit signals back to the source from which the receiver receives its signals, thereby realising full-duplex communication between two nodes. Likewise, the signals transmitted by the transmitter will preferably be different from the signals received by the receiver, so that the transceiver is not merely a repeater, re-broadcasting the received signals.

The transmitter preferably conforms to the FCC regulations for Television Band Devices, Title 47 CFR Part 15, Subpart H.

The transceiver preferably comprises: a geolocation unit, for determining its location; and a database-access part, for accessing a database describing the geographic allocation of spectral bands, in order to determine a band which is permitted for use at that location.

The transceiver preferably comprises a spectrum-sensing unit, for detecting a transmission in a spectral band, in order to determine whether that band is available for use by the transmitter or is presently in use by another transmitter.

The signals transmitted in the TV band may be modulated according to an Orthogonal Frequency Division Multiplexing, OFDM, modulation scheme.

The transceiver may comprise a second transmitter adapted to transmit a control signal to the other device in said different frequency band, the control signal containing instructions to the other device about the television band that will be used by the transmitter to transmit the data signal.

The second transmitter may be the same transmitter as the first or a different transmitter.

The different band is preferably an unlicensed band. The unlicensed band is preferably an Industrial, Scientific and Medical, ISM, band. The unlicensed band is preferably the ISM 900 band, at 902-928 MHz.

The receiver may be adapted to receive signals transmitted using a spread spectrum modulation scheme.

The transceiver may be a fixed device.

For example, the device may be an access-point or base-station.

Also provided is a communications network comprising: an access-point comprising a transceiver as described above; and at least one portable transceiver as described above.

### BRIEF DESCRIPTION OF THE DRAWINGS

The invention will now be described by way of example with reference to the accompanying drawings, in which:

FIG. 1 shows an overview of a communications network according to an embodiment of the invention;

FIG. 2 shows a portable device according to the embodiment of FIG. 1 in greater detail;

FIG. 3 shows an access-point device according to the embodiment of FIG. 1 in greater detail;

FIG. 4 is a flowchart illustrating a communications method performed by the access-point of FIG. 3;

FIG. 5 is a graph of spectral mask requirements, comparing the requirements for TVBD devices and an ISM 900 band device; and

FIG. 6 is a flowchart illustrating a configuration procedure for the portable device of FIG. 2.

### DETAILED DESCRIPTION OF EMBODIMENTS

The following is a summary of the considerations for transmitters of all fixed/portable TV Band Devices (TVBDs), for conditional access in the TV band:
Reliable spectrum-sensing mechanism
Location-awareness capability, functionally similar to a GPS
Database access capability (for example, an internet connection)—this allows the position of the device to be crosschecked against those of other, licensed users, in order to ensure that a frequency band is vacant and authorized for TVBD operation.

Some of the difficulties in spectrum-sensing are as follows. Spectrum-sensing before transmission is complicated because the spectrum availability is not uniform. Although fixed devices are allowed to transmit in 48 channels and portable devices are allowed to transmit in 30 channels, it is found in practice that on average only 10 channels are available for fixed device operation and only 20 channels are available for portable device operation. Also, adjacent channel transmission is not permitted for fixed devices but is allowed for portable devices. The White Space availability varies from area to area, depending upon the population and spectrum usage (by other licensed users) in that area. Hence, it is found that the available spectrum is not uniformly distributed.

Establishing a location-awareness capability is the second challenge. This includes the need for an internet connection, to access a database containing information about: the device location in terms of geographic co-ordinates (for example, longitude and latitude); a list of vacant channels available; transmit power level in ERP; and height of the transmit antenna above average terrain (HAAT). Hence, the geo-location capability for a portable TVBD is similar to a GPS with Wi-Fi enabled. This requires the access of the 2.4 GHz band (Wi-Fi) so as to access the UHF band. Moreover, the position co-ordinates of a portable device change when the device is moved. Hence, there is a need to re-access the database and update the position of these devices, whenever their location is changed. Consequently, it is more complicated to develop geo-location capability for a portable device than a fixed device.

The strict limits for the out-of-band emissions require the design of complex band pass filters, in order to control electromagnetic emissions due to transmission at adjacent channels, non-adjacent channels, and—in the USA, for example—especially in channels 36-38.

In the context of the FCC regulations in the USA, for example, one challenge is to develop a receiver that can detect Digital Televsion (DTV) and wireless microphone signals at a level as low as −114 dBm. This signal detection threshold is very difficult to attain. The noise power of a DTV/wireless microphone signal averaged at 6 MHz bandwidth is =−174+(10*log 10 (6*10⁶))=−106.218 dBm. Although, wireless microphone signals occupy only 200 KHz, the noise floor is calculated at 6 MHz so as to take into account the DTV signals that operate at 6 MHz. Assuming the noise figure of the signal to be around 8 dBm, the noise floor is =−106.218+8=−98.2 dBm. Subtracting this value from the minimum required detection threshold of −114 dBm, it is seen that the SNR of the signal to be detected is around −15 dB. So, in a 6 MHz channel, it is necessary to detect DTV and wireless microphone signals having an SNR of −15 to −20 dB. The biggest challenge is to choose an RF architecture which can detect DTV and wireless microphone signals at such low SNR values.

The main challenges due to the FCC regulations in the RF architecture are:
To implement a spectrum sensing algorithm to operate in a dynamically changing environment.
To establish a geo-location capability with an internet connection, to access a database to check the position of the device against the existing licensed users.
The following spectral emission requirements and sensing threshold requirements are set:

TABLE 1
comparison of spectral mask requirements in fixed and portable devices at
different frequencies.

| | | REQUIREMENTS | |
|---|---|---|---|
| | | FIXED | PORTABLE |
| SPECTRAL | CHANNEL ADJACENT TO | 72.8 dB | 72.8 dB |
| MASK | THE OPERATING | | |
| | CHANNEL | | |
| | ANY NON-ADJACENT | 86.8 dB | 86.8 dB |
| | CHANNEL | | |

| | | |
|---|---|---|
| SENSING THRESHOLD | −114 dBm | −114 dBm |

According to an embodiment of the present invention, the portable devices use the White Space frequencies in the TV band for receive purpose only. This avoids the need to meet the strict FCC requirements for the portable devices. Instead, transmission by the portable devices uses the ISM 900 MHz band (902-928 MHz band, with center frequency at 915 MHz). This ISM 900 MHz band is used for unlicensed operations in Region 2 which includes the Americas, Greenland and some of the Eastern Pacific Islands. As a result, these exemplary devices are designed for use only in the countries in Region 2.

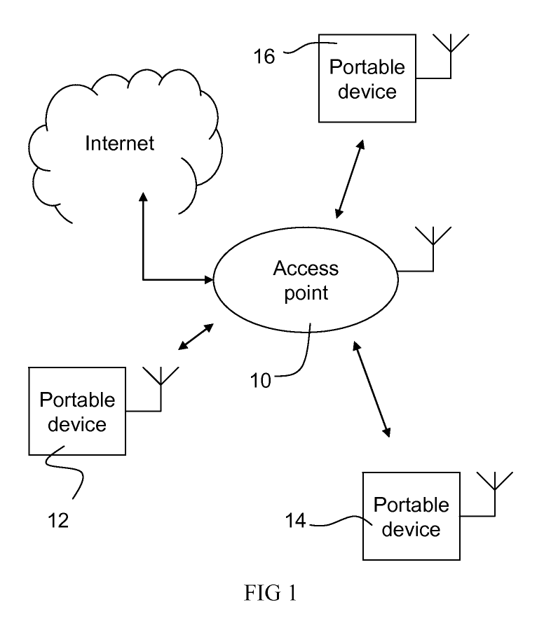

FIG. 1 shows a communications network according to such an embodiment. An Access Point (AP) 10 communicates wirelessly with three portable devices 12, 14, 16. The access point 10 also has a connection to the internet. Such a network may be used for providing wireless broadband internet access for portable wireless devices 12, 14, 16 over a wide area.

This approach creates an asymmetrical link for transmit and receive purposes. The portable devices 12-16 have a wide bandwidth in the receive mode (the entire TV white space spectrum), but a limited bandwidth in the transmit mode (only the ISM 900 MHz band). As a result, the download speed is much higher than the upload speed. There may be a number of such portable devices 12-16 in a given area but they are connected to a common fixed device 10 which acts as an Access Point (AP). The AP 10 is connected to the database via the internet and is capable of transmitting at White Space frequencies. Optionally, the AP 10 may be capable of receiving at TV White Space frequencies. This function may be useful to allow the AP 10 to communicate at a high data-rate with other Access Points within range. Additionally, the AP 10 also receives at the ISM 900 MHz band, which is the transmission frequency of the portable devices 12-16. For transmitting to the portable devices, the AP can operate only in the channels 21-36 (512-608 MHz) and 38-51 (614-698 MHz). This is due to the FCC regulations which state that fixed devices can communicate with portable devices only using channels 21-51 (with the exception of channel 37).

These unlicensed devices 10-16 should tolerate interference from other licensed users and must not cause interference to the licensed users. Hence, for transmission in the 900 MHz band, Direct Spread Spectrum modulation techniques are used. Meanwhile, for reception, the White Space frequencies can be used from 512-608 MHz and 614-698 MHz. For operation in WS frequencies OFDM type modulation is used.

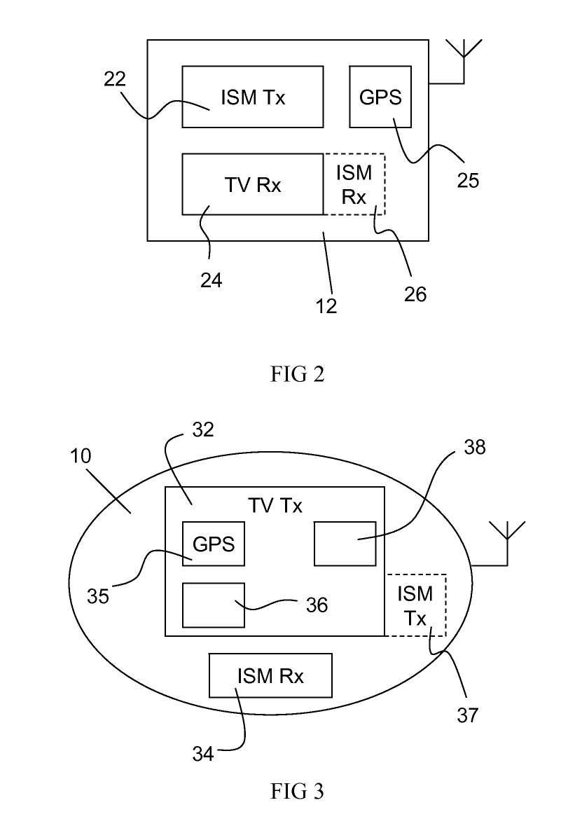

FIG. 2 is a simplified block diagram of a portable device 12 in greater detail. The transmitter 22 of the portable device is operable to transmit in the ISM 900 MHz band, using DSSS modulation, as explained above. Construction of such a transmitter 22 will be straightforward for those skilled in the art. The receiver 24 is adapted to receive signals from a transmitter in a TVBD. Thus, the receiver is adapted to receive signals in the TV band white space. The receiver 24 is adapted to receive signals modulated using OFDM. TV band receivers are well-known in the art. Design of a TV band receiver device for receiving OFDM transmissions will be well within the capabilities of those of ordinary skill in the art.

The portable device 12 also includes a geolocation unit 25, which in this embodiment is a GPS receiver. This enables the device to determine its location and hence to determine the correct ISM band to use, as will be described in greater detail below. The device 12 also includes an ISM band receiver 26, for receiving instructions from an access point 10 about which TV band to use for receiving data signals from the access point 10. In other words, the receiver 26 allows the portable device 12 to learn, from the access point, the TV band frequencies which the access point will use for transmitting its data signal. In this embodiment, the ISM receiver 26 is provided by the same receiver as the TV band receiver 24. Thus, there is a single, tuneable physical receiver, fulfilling both purposes. Of course, in other embodiments, there may be two separate physical receivers.

FIG. 3 is a simplified block diagram showing an access point device 10 in greater detail. The AP 10 comprises a TV band transmitter 32, for transmitting data signals to the portable devices 12-16, and an ISM 900 MHz band receiver 34, for receiving data signals from those devices. The transmitter 32 uses OFDM modulation for its transmitted TV band signals. The receiver 34 receives DSSS modulated signals.

The TV band transmitter 32 comprises a geolocation unit 35, which in this embodiment comprises a GPS receiver. It also comprises a database access unit 36. This unit 36 is arranged to communicate, via the internet connection (not shown in FIG. 3) with a database of TV band transmitter licences. Database access unit 36, in conjunction with geolocation unit 35, is operable to determine which broadcasters are licensed to use channels in the TV band, in the geographic area in which the access point 10 is located. This avoids the AP 10 attempting to transmit on a channel that is in use by a licensed service. Transmitter 32 also includes a spectrum-sensing unit 38, for detecting signals transmitted in the TV band, in order to check whether a particular channel is currently occupied at the present time, at the location of the AP 10. TV band devices which satisfy the FCC regulations are well known in the art for example the TDA18292 or TDA18273 from NXP semiconductors. It will therefore be apparent to those skilled in the art how to design and build a suitable OFDM transmitter 32. Likewise, the skilled person will have no trouble implementing a suitable receiver 34 for receiving DSSS modulated ISM 900 MHz band signals.

The access point 10 also includes an ISM band transmitter 37. This transmitter is used for controlling and coordinating the communication between the access point 10 and mobile devices 12-16. In particular, the initial setup of the communications link between the access point and a given mobile device is arranged using ISM band communications. Communications in the ISM band are unlicensed; therefore, there is no need for the complex checks that precede transmissions in the TV white space. Using relatively simple (and typically low data-rate) communications in the ISM band, each mobile device 12-16 can discover, from the access point 10, which TV white-space bandwidth is being used by the access point 10 for transmissions. Thus, each portable device 12-16 can discover the frequency to which it should tune its TV band receiver 24.

In this embodiment the ISM band transmitter 37 is implemented as part of the TV band transmitter 32. That is, there is a single physical transmitter circuit, which can tune either to a TV band, or to an ISM band. In other embodiments, physically separate transmitters may be provided.

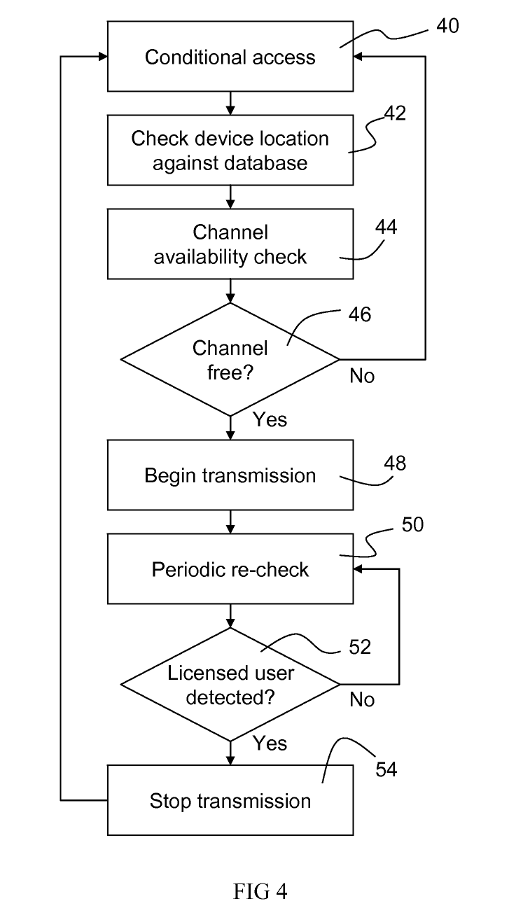

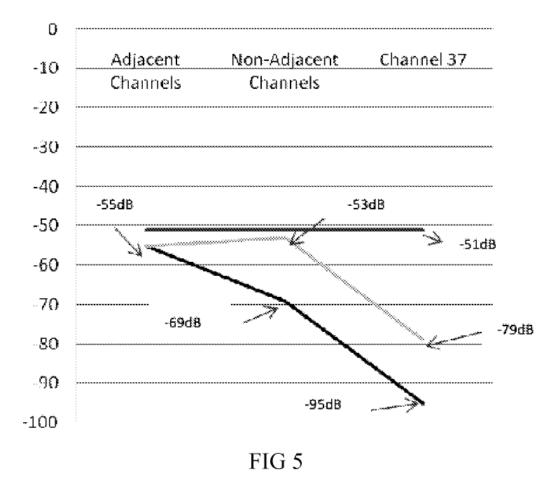

FIG. 4 shows a sequence of operations performed by the transmitter 32 when it is in use. At step 40 the transmitter performs conditional access of the frequency channels, by using spectrum-sensing unit 38 to check which (if any) channels are vacant at the present time. Next, at step 42, the vacant channels are cross-checked against an existing database of licensed users, to check if these channels have been licensed for use in the vicinity of the access point 10. For this cross-check 42, the current position of the AP 10 is provided by the geolocation unit 35. A channel availability check 44 is then performed 30 seconds before the transmitter 32 begins transmitting. If, at step 46, it is determined that the channel is free, then transmission begins at step 48. If not, the procedure returns to the conditional access step 40. While transmission is ongoing, a re-check 50 is periodically performed, to see if a licensed service has started broadcasting in the time that the unlicensed transmitter 32 has been transmitting. If a transmission of a licensed user is detected in step 52, then transmission stops 54 and the channel is vacated within 2 seconds. Otherwise, the periodic check 50 is repeated.

Further details of the embodiment illustrated by FIGS. 1 to 4 will now be described.

Operation of a low-power, unlicensed device is permitted in the 902-928 MHz band of the RF spectrum, provided it abides by the FCC regulations under part 15.247 or 15.249 of Title 47 of the Code of Federal Regulations. A device operating under 15.247 faces restrictions on the modulation scheme that can be employed. Such a device can use only a Frequency Hopping Spread Spectrum (FHSS) method or a Direct Sequence Spread Spectrum (DSSS) modulation scheme for transmitting. A device operating under 15.249 does not face any restriction in the modulation scheme.

According to FCC 15.249, a device is permitted to generate a field strength of only 50 mV/m (50,0000 μV/m), at a distance of 3 m from the radiating source. The transmitting power for such a device operating under FCC 15.249 is P_{TX}=20*log 10(50000*3)−104.77=−1.24 dBm. This is roughly equivalent to 0.79 mW. It is not desirable to operate at such low transmitting powers.

Consequently, the transmitter 22 in the portable device according to the present embodiment operates under 15.247. Devices which operate under 15.247 are allowed to transmit up to 1 W (30 dBm). However, they should employ either a FHSS or DSSS modulation method.

In Frequency Hopping Spread Spectrum, the transmitter hops between the available frequencies, according to a specific, pre-planned algorithm, which is known to both the transmitter and receiver. Although the bandwidth is much higher, the actual transmission at any given time instant occurs at only one carrier frequency. The receiver must be synchronized with the transmitter so that if the channel is occupied, the transmitter hops until it finds a free channel to retransmit the data.

In Direct Sequence Spread Spectrum, the transmitted signal is multiplied (modulated) with a Pseudo-Random Numerical (PRN sequence) of +1 and −1, which spreads the spectrum into a much wider band. The reverse process takes place at the receiver. There are specific regulations for FHSSS and DSSS modulation schemes.

The devices which employ FHSS are allowed to operate at 1 W (30 dBm) for systems with at least 50 hopping channels and 0.25 W (24 dBm) for systems employing fewer than 50 channels but more than 25 channels. All DSSS type modulation systems are allowed to operate up to 1 W (30 dBm). It is for this reason that a DSSS scheme operating under 15.247 is used in the present embodiment of the transmitter 22, for use in the USA.

Nevertheless, by now it will be apparent to those skilled in the art that it is also possible to implement the invention using a FHSS system, or indeed, using a low-power transmitter under part 15.249 of the Federal Regulations.

All systems which use FHSSS and DSSS are allowed a maximum directional antenna gain of 6 dBi. For any increase of antenna gain above 6 dBi, there must be a corresponding drop in the transmitted output power.

For DSSS, the 6 dB bandwidth of the system should be a minimum of 500 KHz. This is to ensure that the energy is spread out widely enough, so that there are no interference issues. The FCC requires a spread spectrum of a minimum of +/−250 KHz on either side of the center frequency. This means that when the signal power drops by 6 dB, the spreading is still +/−250 KHz from the centre. Although the maximum transmitted power is 30 dBm, the power spectral density cannot exceed 8 dBm in any 3 KHz bandwidth during any transmission. This means that if the spectrum power of 1 Watt is spread over the bandwidth of 500 KHz, then the power at every 3 KHz bandwidth is =(1/500 KHz)*3 KHz=0.006 W or 6 mW or 7.78 dBm˜8 dBm.

The device is assumed to be transmitting a maximum power of 1 W, in a signal bandwidth of 80 KHz. (The value of signal bandwidth is chosen as 80 KHz because it is a nominal value considering the channel bandwidth of 100 KHz). The spectral mask requirement for an out-of-band transmit power in a 100 KHz channel bandwidth can be calculated using the formula:

$$Spectral Mask requirement = \{ TX power - 10 * LOG 10 ( BW / 100 ) \} - ( Out \text{-} of \text{-} band emission power ) = \{ 30 - ( 10 * LOG 10 ( 80 / 100 ) \} - ( - 20 dB ) = 50.96 dB ∼ 51 dB$$

Thus, devices operating in the frequency range of 902-928 MHz, and which use FHSSS/DSSS modulation schemes for transmission purposes, require a uniform spectral mask of 51 dB.

The devices according to the presently described embodiment are intended for use in ITU Region 2, which includes the Americas, Greenland and Pacific Islands. However, similar devices using corresponding regulated bandwidths could be used in other regions.

The portable devices 12-16 according to the present example use the ISM 900 MHz band (902-928 MHz) for transmit purposes. The White Space (WS) frequencies from 512-698 MHz (except 608-614 MHz) are used for receiving alone.

For operation in the 900 MHz band, DSSS modulation scheme is used. For operation in WS frequencies, OFDM modulation scheme is used. Spread spectrum techniques cannot be used in the WS frequencies.

An access point 10 is provided, having an internet connection; the ability to transmit and receive in WS frequencies; and the ability to transmit and receive at 900 MHz. This access point can transmit to the portable device only in the band 514-698 MHz (excluding 608-616 MHz), when used in the USA.

A transmit power of up to 1 Watt can be used. The Power Spectral Density (PSD) does not exceed 8 dBm in any 3 KHz bandwidth, when operating at the maximum power of 1 W.

The asymmetric communications link has the following advantages:
The portable devices need not support an internet/database system to verify whether a channel is available or not.
The problem of signal detection at the extremely low signal threshold of −114 dBm is avoided.
The maximum transmitted power is boosted from 100 mW (for portable devices operating in White Space frequencies) to 1 W (for portable devices 12-16 transmitting in 900 MHz band).

The problem of designing a very complex spectral mask is also avoided when transmission occurs in the 900 MHz band or in any ISM band allowed. The spectral mask requirement is uniform (51 dB) for devices operating in 900 MHz band. This is illustrated in FIG. 5, which clearly shows that the spectral mask requirement is uniform for 900 MHz band devices whereas it dynamically changes for TVBDs operating at WS frequencies. In FIG. 5, the Y-axis shows the spectral mask requirement in decibels (dB). In the X-direction, three sets of requirements are shown: for an adjacent channel; for a non-adjacent channel; and for channel 37, respectively. The uppermost plot is the mask derived for ISM 900 MHz band transmissions; the middle plot shows the mask for a portable TVBD at WS frequencies; and the lowermost plot is the mask for a fixed TVBD at WS frequencies.

To set up a power amplifier for the entire bandwidth of White Space frequencies (from 54 MHz-1 GHz), compromises efficiency, because of the large bandwidth of operation. Therefore, in order to transmit in the White Space frequencies, it is necessary to use multiple different power amplifiers, each for a different bandwidth—dividing the full bandwidth into smaller portions—and also to use sharp tuning filters to meet the spectral emission requirements at different frequencies. These disadvantages are overcome (in the portable devices 12-16) by using an asymmetric link, as described above. In this case, for transmission in the 900 MHz ISM band, a single power amplifier and a fixed filter is sufficient.

The transmitters 22, 32, 37 and receivers 24, 26, 34 of the transceivers according to the various aspects of the invention are preferably tuneable, so that they can use different channels within a given allocated portion of the radio spectrum and also so that they can be configured for use in different parts of the world. It is desirable that a transceiver is not limited to using a set of frequencies which is allocated in one particular country or region, but rather the transceiver is flexibly and conveniently customisable, so that it can be used in accordance with spectrum regulations in any part of the world. For example, a TV band transmitter 32 or TV band receiver 24 is preferably tuneable over a range extending from 76 MHz to 1 GHz. This range encompasses several ISM bands, which means that ISM receiver or transmitter functions can be provided by the same physical receiver or transmitter, respectively, as the TV band functions.

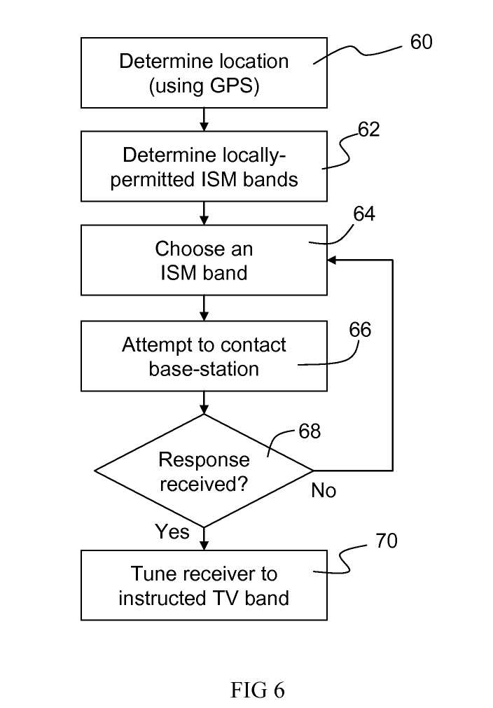

A configuration method for a portable transceiver will now be described, with reference to FIG. 6. The method is suitable for providing the desired flexibility.

The portable transceiver 12 is switched on and determines 60 its location, using GPS receiver 25. By knowing its location in the world, the transceiver 12 is able to determine 62 which unlicensed bands are available in that locality (country/region). The transceiver may include an onboard database or lookup table containing a list of countries and corresponding frequency band allocations. In particular, the database or table may contain information about the allocation of ISM bands in each locality. Such a database may be stored in a non-volatile solid state memory, such as Flash memory or Read Only Memory (ROM). The database may be updated periodically—for example, in conjunction with a firmware update to the portable device 12.

The portable device 12 chooses 64 one of the permitted unlicensed bands from the available list for the country or region in which it finds itself. The choice may be random; however, some bands may be preferred by the device over others. As noted previously, ISM bands are preferred. Among ISM bands, it may be preferred that the chosen ISM band is as close as possible to the frequency of a TV band. This is because TV band frequencies have good propagation properties; hence, they provide greater range, at equivalent power levels, than other bands. For example, in the USA, the portable device 12 may choose between the 315 MHz ISM band, the 900 MHz ISM band, and the 2.4 GHz ISM band. In this case, the device may prioritise the 315 MHZ or 900 MHz bands, because of their more favourable propagation characteristics. The device may choose the 900 MHz band for its higher permitted power levels, or the 315 MHz band for its greater range (due to better propagation characteristics at increasingly lower frequencies).

Using the selected ISM band, the device 12 attempts 66 to make contact with any base-station 10 nearby. The protocol for this communication may be any suitable procedure which can be agreed in advance between base-stations 10 and portable devices 12-16. For example, a protocol may be standardised among a group of different manufacturers, to ensure interoperability. In the present example, the device 12 listens 68 on the same frequency that it has used in step 66 in its speculative transmission to alert base-stations to its presence. Upon detecting such an initial transmission from a portable device 12, a base-station 10 will respond with information about the particular TV white space band that the base-station 10 is using (or will begin using to communicate with portable device 12). These instructions enable the portable device 12 to tune to the correct TV white space frequency.

Consequently, if a response from a base-station 10 is detected in step 68, the TV band receiver 22 in the portable device 12 is tuned to the instructed TV band. The device 12 can then begin receiving high-bandwidth transmissions from the base-station 10.

If no response is detected in step 68, the portable device 12 may try again to initiate communication. The procedure returns to step 64 and the device selects another band (for example, a less preferable ISM band) from the list of permitted bands at its current location. The device then attempts to contact any base-stations within range using this selected band. Eventually, provided there is a base-station 10 within range, the portable device will receive a response in one of the unlicensed bands and will be able to configure its TV band receiver.

In this way, the portable device 12 provides an initial automatic self-configuration (based on location). It then performs further automatic configuration, by interacting with a nearby base-station 10. The portable device receives configuration instructions from this base station 10, enabling the portable device to being receiving TV white space data signals.

The base station 10 should also be configured when it is activated in a new location for the first time. The initial self-configuration may be similar to that for the portable device 10, using geolocation function 35 to determine the country or region in which the base-station 10 is located. However, since the base-station 10 is more likely to be part of a fixed infrastructure network, it may be appropriate to instead manually configure it upon installation.

While the invention has been illustrated and described in detail in the drawings and foregoing description, such illustration and description are to be considered illustrative or exemplary and not restrictive; the invention is not limited to the disclosed embodiments.

The portable device 12 and access-point/base-station 10 described above both include a geolocation function, provided by GPS. As those skilled in the art will appreciate, aspects of the invention are not limited to use of GPS as the position system. For example, other Global Navigation Satellite Systems (GNSS) may equally be used. Examples include GLONASS and Galileo.

In other embodiments, use of a satellite positioning system may be avoided altogether. Convergence in functionality is a common feature of modern electronics devices. In some embodiments of the invention, the portable transceiver (for example) may be collocated with a cellular telephone or WLAN client. Both of these technologies can be used to obtain location data. In cellular telephony, it is common for a base-station to identify itself by a label which includes a country code (for example, a Mobile Country Code, MCC). A cellular telephone detecting the MCC of a local network can determine which country it is located in. Similarly, it is known to use the identities of conventional Wireless LAN access points as a fingerprint for a specific location. That is, the location can be deduced from the set of addresses of one or more WLAN access points which are detectable by the WLAN client in its vicinity. Both of these location-finding methods (and others) are within the scope of the present invention.

Transceivers according to embodiments of the various aspects of the invention may be digital radio transceivers or analogue radio transceivers.

Data signals transmitted and received according to embodiments of the invention may be digital or analogue data signals. The data signal can be an information signal of any kind, including, but not necessarily limited to: information representing a voice signal or other audio data; an image or video signal or other visual data; or textual or numerical data.

The TV band receiver in the portable device may receive signals with other types of modulation, in addition to or as an alternative to OFDM modulation. That is, the receiver is not limited to using OFDM.

Devices according to embodiments of the various aspects of the invention may be useful in various applications, of which the following is a non-exhaustive list: wide-area connectivity, utility grid networks, transportation logistics, land mobile connectivity, maritime connectivity, high speed vehicle broad band access, office and home networks, communications for emergencies and public safety, long-range push-to-talk, interactive entertainment and local media on demand.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfil the functions of several items recited in the claims. The mere fact that certain measures are recited in mutually different dependent claims does not indicate that a combination of these measured cannot be used to advantage. Any reference signs in the claims should not be construed as limiting the scope.

1. A wireless transceiver comprising:
a receiver adapted to receive a data signal from another device in a television broadcast band; and
a transmitter adapted to transmit a data signal to that other device using a different frequency band, which is not a television broadcast band,
the transmitter and receiver thereby being adapted to implement frequency division duplex communication between the transceiver and the other device.

2. The wireless transceiver of claim 1, further comprising a geolocation unit, wherein the transceiver is adapted to:
determine its location using the geolocation unit, and
select said different frequency band in dependence upon the determined location.

3. The wireless transceiver of claim 2, wherein the transceiver comprises a second receiver adapted to receive a control signal from the other device in said different frequency band,
the transceiver being adapted to determine the television band to be used for receiving the data signal according to instructions contained in the control signal.

4. The transceiver of claim 1, wherein the receiver is adapted to receive signals in the television band that are modulated according to an Orthogonal Frequency Division Multiplexing, OFDM, modulation scheme.

5. The transceiver of claim 1, wherein the different band is an unlicensed band, optionally, an Industrial, Scientific and Medical, ISM, band, and, more optionally, the ISM 900 band, 902-928 MHz.

6. The transceiver of claim 1, wherein the transmitter uses a spread spectrum modulation scheme.

7. The transceiver of claim 1, wherein the transceiver is a mobile device.

8. A wireless transceiver comprising:
a transmitter adapted to transmit a data signal to another device in a television broadcast band; and
a receiver adapted to receive a data signal from that other device in a different frequency band, which is not a television broadcast band,
the transmitter and receiver thereby being adapted to implement frequency division duplex communication between the transceiver and the other device.

9. The transceiver of claim 8, wherein the transmitter conforms to the FCC regulations for Television Band Devices, Title 47 CFR Part 15, Subpart H.

10. The transceiver of claim 8, wherein the transceiver further comprises:
a geolocation unit, for determining its location; and
a database-access part, for accessing a database describing the geographic allocation of spectral bands, in order to determine a television band which is permitted for use at that location.

11. The transceiver of claim 8, wherein the transceiver further comprises a spectrum-sensing unit, for detecting a transmission in a television band, in order to determine whether that band is available for use by the transmitter or is presently in use by another transmitter.

12. The transceiver of claim 8, wherein the signals transmitted in the TV band are modulated according to an Orthogonal Frequency Division Multiplexing, OFDM, modulation scheme.

13. The transceiver of claim 8, wherein the transceiver further comprises a second transmitter adapted to transmit a control signal to the other device in said different frequency band,
the control signal containing instructions to the other device about the television band that will be used by the transmitter to transmit the data signal.

14. The transceiver of claim 8, wherein the different band is an unlicensed band, optionally, an Industrial, Scientific and Medical, ISM, band.

15. The transceiver of claim 8, wherein the receiver is adapted to receive signals transmitted using a spread spectrum modulation scheme.

16. The transceiver of claim 8, wherein the transceiver is a fixed device.

17. A communications network comprising:
an access-point comprising a transceiver; and
at least one transceiver according to claim 1.
